(19) United States
(12) Patent Application Publication
(10) Pub. No.: US 2026/0295310 A1
(43) Pub. Date: Oct. 1, 2026

(54) Lung Demand Regulator

(71) Applicant: Dräger Safety AG & Co. KGaA, Lübeck (DE)

(72) Inventors: Iain Brechtelsbauer, Whitley Bay (GB); Paul Nicholas Townsend, Cramlington (GB)

(21) Appl. No.: 19/569,097

(22) Filed: Mar. 17, 2026

(30) Foreign Application Priority Data
Mar. 27, 2025 (GB) 251666152

(51) Int. Cl. A62B 18/10; A62B 18/02

(52) U.S. Cl. CPC A62B 18/10; A62B 18/02

(57) ABSTRACT

A lung demand regulator for a breathing apparatus may include an ambient valve having: a bypass configuration in which the ambient valve is configured to permit a flow of gas between a first side of the ambient valve and a second side of the ambient valve; a non-return configuration in which the ambient valve is configured to permit a flow of gas from the first side of the ambient valve to the second side of the ambient valve, and prevent a flow of gas from the second side to the first side; and a lockout mechanism having a lockout configuration in which the ambient valve is held in the bypass configuration, and an unlocked configuration in which the ambient valve is biased into the non-return configuration. Also disclosed is a breathing apparatus comprising a lung demand regulator.

### CROSS-REFERENCE TO RELATED APPLICATIONS

This application claims the priority of European Patent Application No. 25166615.2 filed on Mar. 27, 2025, and titled “Lung Demand Regulator”, which is hereby incorporated by reference in its entirety for all nonlimiting purposes.

### TECHNICAL FIELD

The present disclosure relates to lung demand regulators of self-contained breathing apparatus systems, and more specifically to the conservation of breathing gas in such systems.

### BACKGROUND

Firefighters and other emergency personnel are regularly faced with responding to incidents in challenging and often dangerous environments. These environments are often categorised as immediately dangerous to life or health (IDLH). IDLH environments may include environments with toxic or harmful gases or particulates which, if inhaled, could lead to sickness or death. In order to operate in IDLH environments, firefighters use self-contained breathing apparatus (SCBA) system. These systems provide the user with safe, breathable gas on demand from a compressed gas supply, so that they are not at risk of breathing in any harmful environmental components.

The compressed gas supply of an SCBA system has a finite capacity, which dictates the amount of time it can sustain a user in an IDLH environment. Once the supply is substantially depleted, the user must retreat from the IDLH environment and replenish the compressed gas supply.

Generally, once a user dons their SCBA, they will begin to consume the breathing gas stored within the compressed gas supply, even if they are not yet within the IDLH environment. This period of time where the compressed gas supply is being depleted, but the user is not in the IDLH environment, reduces the overall time that the user can operate in the IDLH environment.

It will therefore be appreciated that advancements in lung demand regulator which better conserve compressed gas supply are desirable.

### SUMMARY

According to a first aspect, there is provided a lung demand regulator for a breathing apparatus. The lung demand regulator comprises an ambient valve having: a bypass configuration in which the ambient valve is configured to permit a flow of gas between a first side of the ambient valve and a second side of the ambient valve; and a non-return configuration in which the ambient valve is configured to permit a flow of gas from the first side of the ambient valve to the second side of the ambient valve, and prevent a flow of gas from the second side of the ambient valve to the first side of the ambient valve. The lung demand comprises a lockout mechanism having a lockout configuration in which the ambient valve is held in the bypass configuration, and an unlocked configuration in which the ambient valve is biased into the non-return configuration.

The ambient valve may be in fluid communication with an ambient environment. The ambient valve may provide a flow path between an internal chamber of the lung demand regulator and an ambient environment.

The ambient valve may comprise a sealing seat and a sealing element moveable relative to the sealing seat. The sealing element may be biased to seal against the sealing seat.

In the lockout configuration, the lockout mechanism may maintain a separation between the sealing element and the sealing seat to provide a flow path therebetween.

The sealing element may comprise an engagement portion extending through the sealing seat. The lockout mechanism may be arranged to push against the engagement portion to separate the sealing element from the sealing seat.

In the unlocked configuration, biasing of the sealing element may cause the sealing element to seal against the sealing seat.

The sealing element may be configured to move outwardly from the sealing seat relative to the lung demand regulator when the ambient valve opens. The term “outwardly” may be understood to mean in a direction from the first side of the ambient valve towards the second side of the ambient valve.

The sealing seat may be an annular sealing seat. The sealing element may be configured to move axially relative to the annular sealing seat.

A direction of gas flow between the sealing element and sealing seat may be substantially perpendicular to a direction of movement of the sealing element.

The lung demand regulator may comprise a diaphragm between the internal chamber and the ambient environment. The ambient valve may provide a flow path through the diaphragm between the internal chamber and the ambient environment.

The diaphragm may be configured to deform in response to a deformation force caused by a pressure gradient between the internal chamber and the ambient environment.

The lung demand regulator may further comprise a flow regulation mechanism coupled to the diaphragm, optionally by a lever arm. The lever arm may be configured to pivot in response to deformation of the diaphragm to thereby actuate a valve of the flow regulation mechanism to provide a flow of gas into the internal chamber.

The lockout mechanism may comprise a lockout lever. The lockout lever may be configured to: in the lockout configuration, engage the diaphragm and resist movement of the diaphragm when a pressure gradient between the internal chamber and the ambient environment is below a threshold. The lockout lever may be configured to: in the unlocked configuration, disengage the diaphragm and permit movement of the diaphragm when the pressure gradient between the internal chamber and the ambient environment exceeds the threshold.

The phrase “exceeds the threshold” may include meeting and/or exceeding the threshold.

When the pressure gradient between the internal chamber and the ambient environment exceeds the threshold, the sealing element may push against the lockout lever to move the lockout mechanism into the unlocked configuration and move the ambient valve into the non-return configuration. The threshold may correspond to a pressure gradient where a pressure in the internal chamber is at least 5 kPa less than a pressure in the ambient environment or at least 6.5 kPa less than a pressure in the ambient environment.

The ambient valve may comprise a manual setting mechanism configured to maintain the ambient valve in either the bypass configuration or the non-return configuration. The setting mechanism may comprise a rotatable setting element having at least one keying feature extending radially therefrom. The setting element may be rotatable into a first position corresponding to the bypass configuration in which the at least one keying feature engages the sealing element to separate the sealing element from the sealing seat. The setting element may be rotatable into a second position corresponding to the non-return configuration in which the at least one keying feature disengages from the sealing element to permit the sealing element to seal against the sealing seat.

The sealing element may comprise a flange. In the first position, the at least one keying feature may be aligned with the flange of the sealing element. The setting mechanism may further comprise a biasing element configured to apply a force to the flange of the sealing element via the at least one keying feature to separate the sealing element from the sealing seat.

In the second position, the at least one keying feature may be out of alignment with the flange of the sealing element such that the sealing element may be permitted to move relative to the setting element. Thus, in the second position, the sealing element may be permitted to seal against the sealing seat.

The setting element may be rotatable into a third position in which the sealing plate is maintained in sealing connection with the sealing plate.

At least a portion of the setting element may extend from a body of the lung demand regulator to permit a user to rotate the setting element.

Gas flow through the ambient valve may be an unfiltered gas flow. Unfiltered gas flow may be understood to mean non-filtered gas flow, such as gas which is sourced directly from the ambient environment without filtration.

According to a second aspect, there is provided a breathing apparatus comprising a lung demand regulator according to the first aspect.

### BRIEF DESCRIPTION OF THE DRAWINGS

Arrangements of the invention will now be described, by way of example, and with reference to the accompanying drawings, in which:

FIG. 1 schematically shows a breathing apparatus according to an embodiment;

FIG. 2 schematically shows a facemask and a lung demand regulator according to an embodiment;

FIG. 3 schematically shows a cross-sectional view of a lung demand regulator according to an embodiment;

FIGS. 4A and 4B schematically show a cross-sectional view of an ambient valve of a lung demand regulator according to an embodiment;

FIG. 5A schematically shows a cross-sectional view of an ambient valve of a lung demand regulator according to an embodiment;

FIGS. 5B and 5C each schematically show an axial view of a setting element according to an embodiment; and

FIG. 5D schematically shows a cross-sectional view of an ambient valve of a lung demand regulator according to an embodiment.

### DETAILED DESCRIPTION OF THE DRAWINGS

As discussed above, the finite breathing gas capacity of an SCBA system directly limits the duration of time it can support a user in an IDLH environment. Further, any time a user is breathing though the SCBA system and consuming the compressed gas supply, while not in an IDLH environment, leads to the compressed gas supply being wasted. Wastage of the compressed gas supply reduces the time that the user can spend in the IDLH environment. The present disclosure reduces wastage of compressed breathing gas to maximise the amount of time a user can spend in an IDLH environment.

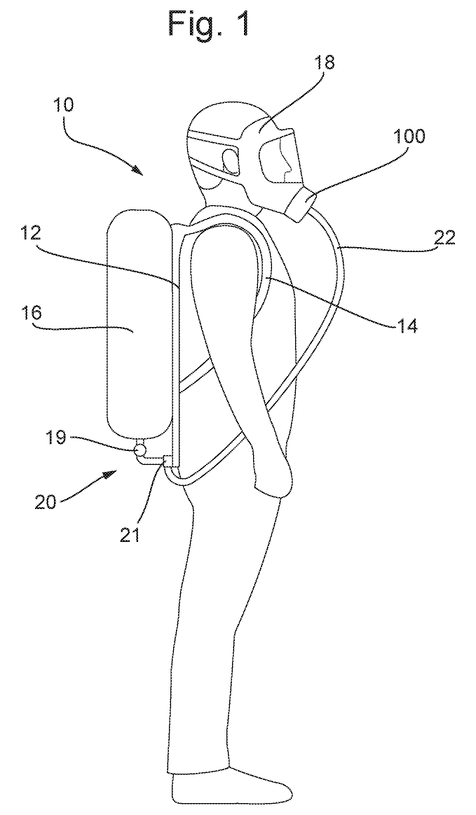

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a flexible conduit or hose 22 to the lung demand regulator 100, to thereby deliver breathing gas to the user wearing the face mask 18 on demand. The pneumatics system 20 is connected to the breathing gas cylinder 16 by a valve 19. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus 10 is a self-contained breathing apparatus (SCBA), but it should be understood that the lung demand regulator may also have applications in other types of breathing apparatus, such as self-contained underwater breathing apparatus (SCUBA) and emergency escape breathing apparatus.

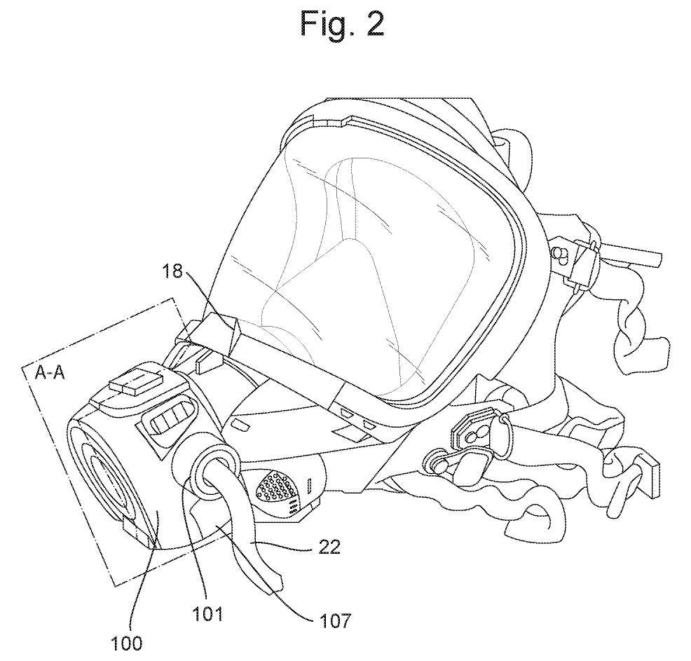

Turning to FIG. 2, a schematic view of the face mask 18 attached to the regulator 100 is shown. The hose 22 of the pneumatics system 20 is connected to an inlet 101 of the regulator 100 to provide breathing gas from the cylinder 16. The pneumatics system 20 comprises a first-stage pressure reducer 21 which reduces the pressure of the breathing air from the cylinder 16 which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided.

As noted above, the breathing gas cylinder 16 stores breathing gas under high pressure. A typical cylinder may have a volume of 6.8 litres and may be designed to contain approximately 2,000 litres (free air volume) of compressed air at a nominal pressure of 300 bar. During physically demanding work, this volume of compressed air may sustain a user for up to 45 minutes.

In existing systems, once a user dons their face mask and begins breathing through their regulator, the breathing gas stored in their cylinder immediately starts to be consumed. Between the user donning their equipment and entering an IDLH environment, there may often be delays which lead to a portion of the breathing gas stored in the cylinder being consumed. Such delays may include the user being briefed on the emergency response strategy, equipment checks (including communications systems checks), waiting for other users to don their equipment, waiting for other emergency responders to gain access to or evacuate from the IDLH environment etc. All of these delays, where the user is consuming their limited supply of breathing gas, reduces the overall time the user can spend operating in the IDLH environment.

The present disclosure generally provides a regulator having an ambient valve which permits a user to breathe ambient air while the breathing apparatus is fully donned, rather than stored breathing gas, while they are not within an IDLH environment. The ambient valve is capable of switching between a bypass configuration in which the supply of breathing gas from the cylinder is ‘bypassed’ and the user can inhale ambient air directly, and a non-return configuration in which the supply of breathing gas from the cylinder is enabled and inhalation of ambient air is prevented. A mechanism is provided to selectively switch between the two configurations.

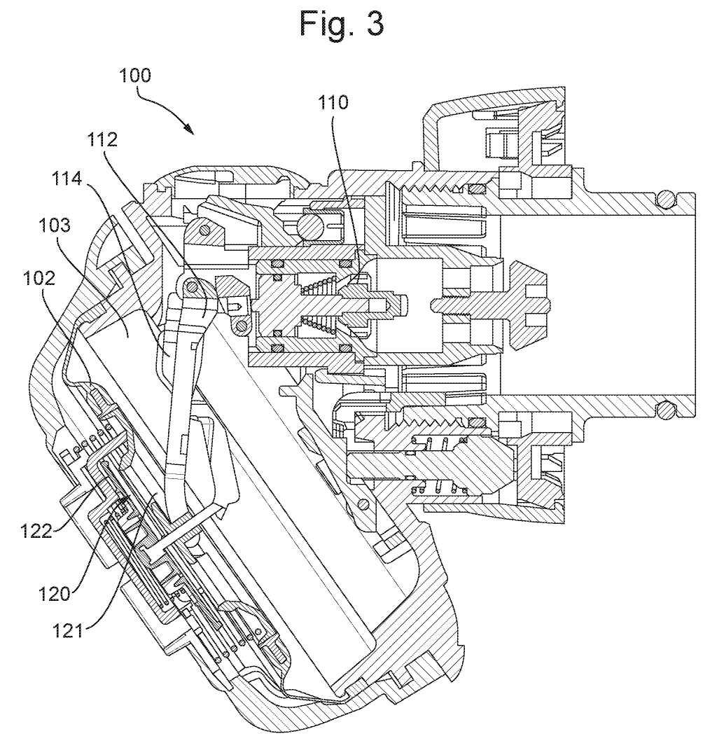

FIG. 3 depicts a cross-sectional view of the regulator 100 in the plane marked A-A in FIG. 2, in accordance with an example embodiment of the present disclosure.

The regulator 100 includes a flexible diaphragm 102 disposed within an internal chamber 103 of the regulator 100. The diaphragm 102 has a first side exposed to the internal chamber and a second side exposed to the ambient environment. The regulator 100 also includes a demand valve 110 which is coupled to the diaphragm 102 by a lever 112. When a user inhales through the regulator 100, a pressure in the internal chamber decreases relative to the ambient pressure. As a result, the diaphragm 102 moves inwards. This inward movement causes the lever 112, which engages the diaphragm 102, to rotate (anticlockwise from the perspective of FIG. 3). Rotation of the lever 112 is transferred to the demand valve 110, which in turn opens, causing breathing gas to enter the internal chamber 103. The introduction of breathing gas into the internal chamber 103 increase the pressure in the internal chamber 103, which results in the diaphragm 102 and the lever 112 returning to their respective original positions and the demand valve 110 closing. The cycle then repeats once the user takes another breath.

In the depicted example embodiment, the regulator 100 also comprises a lockout lever 114. Before the user has taken a first breath, the lockout lever 114 engages the diaphragm 102 and resists movement thereof. In this state, the lockout lever 114 is said to be in the ‘lockout configuration’ and is depicted in FIG. 3. The lockout lever 114 is biased such that any small movements in the diaphragm 102, caused by small decreases in pressure in the internal chamber 103, are resisted by the lockout lever 114 to prevent the diaphragm 102 from moving further and actuating the demand valve 110. Only once the pressure in the internal chamber 103 drops significantly (i.e., as a result of a deep, forceful breath by the user) does the force acting on the diaphragm 102 overcome the resistive force of the lockout lever 114 to allow the demand valve 110 to actuate. Once this pressure drop has been achieved, the lockout lever 114 travels to an ‘unlocked configuration’, in which it no longer interacts with the diaphragm 102, and the regulator 100 functions as described above.

The regulator 100 also includes an ambient valve 120. The ambient valve 120 has a first side 121 in fluid communication with the internal chamber 103 and a second side 122 in fluid communication with the ambient environment. As described above, in a bypass configuration of the ambient valve 120 (depicted in FIG. 3), the ambient valve 120 permits gas to flow therethrough, between the first side 121 and the second side 122. In the bypass configuration, the ambient valve 120 permits gas to flow directly between the ambient environment and the internal chamber 103. In this configuration, the gas flow through the ambient valve 120 is therefore unfiltered. That is to say, there is no filtration of gas flowing through the ambient valve 120 from the ambient environment in the bypass configuration. Of course, filtration is not required at this stage as the user is not within an IDLH environment.

In a non-return configuration of the ambient valve 120, the ambient valve 120 permits gas to flow therethrough from the first side 121 to the second side 122, and prevent gas to flow therethrough from the second side 122 to the first side 121.

In this example embodiment, the ambient valve 120 is disposed within the diaphragm 102. That is to say, the ambient valve 120 permits gas to flow through the diaphragm (in accordance with the bypass and non-return configurations). Though, it will be appreciated that an ambient valve with the features described herein could be disposed on any part of a regulator which defines a boundary between the internal chamber and the ambient environment.

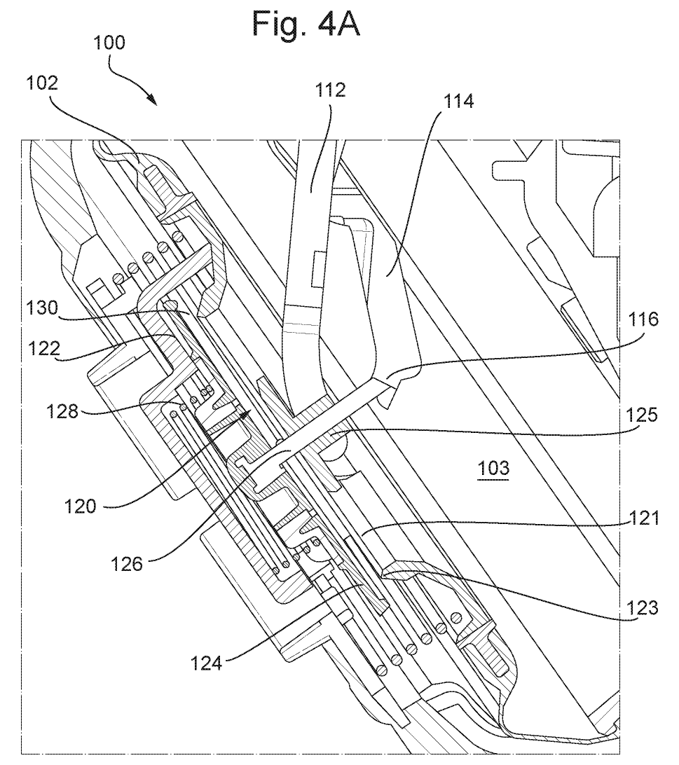

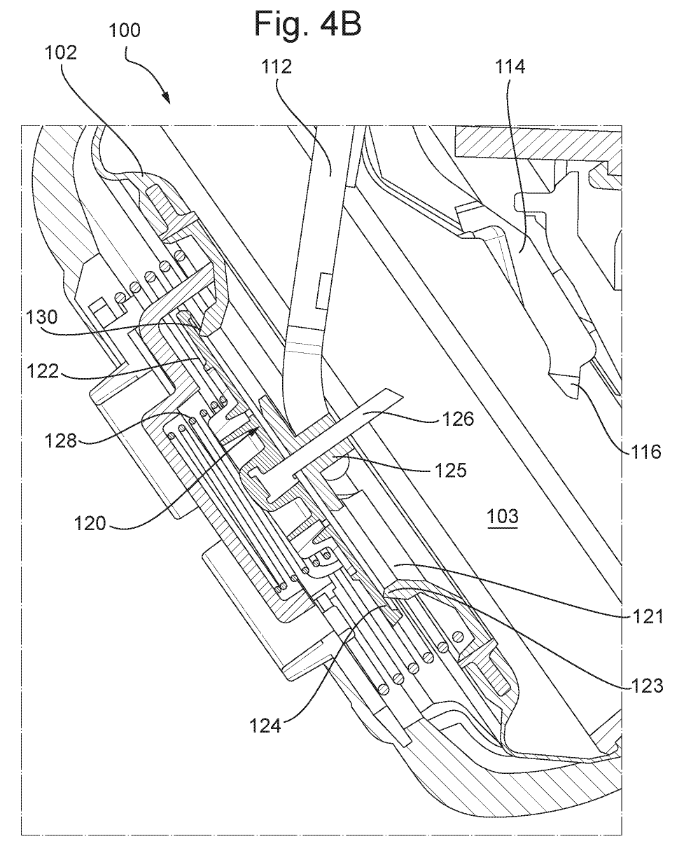

Turning to FIG. 4A, an enlarged view of a section of FIG. 3 is shown. Again, FIG. 4A depicts the ambient valve 120 in the bypass configuration. In this example embodiment, the ambient valve 120 comprise a sealing seat 123 against which a sealing element 124 is configured to seal. The depicted sealing element 124 takes the form of a flat plate. The sealing element 124 is moveable relative to the sealing seat 123. When the sealing element 124 is separated from the sealing seat 123, a flow path 130 is formed therebetween. When the sealing element 124 is engaged with the sealing seat 123, the flow path 130 is closed and gas flow through the ambient valve 120 is prevented.

As shown, the sealing seat 123 is an annular sealing seat with a central support 125. The central support 125 comprises a hole which receives an engagement portion of the sealing element 124 in the form of a rod 126. The combination of the central support 125 and the rod 126 constrain movement of the sealing element 124 relative to the sealing seat 123 such that the sealing element 124 is only permitted to move axially.

The sealing element 124 is biased to move towards the sealing seat 123 by a biasing element 128 in the form of a helical spring. In the non-return configuration of the ambient valve 120, the biasing element 128 causes the sealing element 124 to engage the sealing seat 123, closing the flow path 130 and preventing any gas flow therethrough.

The regulator 100 also comprises a lockout mechanism which, in this example embodiment, takes the form of the lockout lever 114. In the bypass configuration of the ambient valve 120, the lockout lever 114 is in the lockout configuration. In the lockout configuration, a foot 116 of the lockout lever 114 engages a distal end of the rod 126 to maintain a separation between the sealing element 124 and the sealing seat 123. The force applied by the lockout lever 114 to the rod 126 is sufficient to overcome the biasing of the biasing element 128 to ensure the flow path 130 remains open.

In this state, the ambient valve 120 is in the ‘bypass’ configuration. So named, because the ambient valve 120 is held open so a user can breathe ambient air directly through the ambient valve 120, without actuating the demand valve 110.

It will be appreciated that, as the ambient valve 120 forms part of the diaphragm 102 in this example embodiment, when the lockout lever 114 is in the ‘lockout configuration, the lockout lever 114 is capable of performing both the function of preventing movement of the diaphragm 102 as well as maintaining a separation between the sealing element 124 and the sealing seat 123.

As described above, once the pressure inside the internal chamber 103 falls below a threshold value, the lockout lever 114 pivots into the ‘unlocked configuration. FIG. 4B shows the same view as FIG. 4A, but with the lockout lever 114 in the unlocked configuration. Once the lockout lever 114 has moved to the unlocked configuration, the force that the lockout lever 114 was previously applying to the rod 126 is removed. Therefore, the biasing element 128 cause the sealing element 124 to engage the sealing seat 123, closing the flow path 130, as shown.

In this state, the ambient valve 120 is in the ‘non-return’ configuration. Inhalation by the user will cause a decrease in pressure in the internal chamber 103 which will result in the normal functioning of the lever 112 and demand valve 110 as described previously. Exhalation, on the other hand, causes the pressure in the internal chamber 103 to increase. This increase in pressure causes a force to be applied to the diaphragm 102 and thus also the sealing element 124. As a result, the force overcomes the biasing element 128 and causes the sealing element 124 to momentarily separate from the sealing seat 123, opening the flow path 130. Once opened, gas exhaled by the user is ejected out of the regulator through the flow path 130. As soon as the pressure in the internal chamber 103 begins to fall, the biasing element 128 again returns the sealing element 124 to the sealing seat 123, thus preventing any ambient air from entering the regulator 100.

The sealing element 124 is configured to move such that a face of the sealing element 124 remains perpendicular to the sealing seat 123. As depicted in the example embodiment of FIGS. 4A and 4B, the sealing element 124 overlays the sealing seat 123 such that the flow path 130 therebetween is substantially perpendicular to the axis of movement of the sealing element 124 relative to the sealing seat 123. That is to say, gas flow through the flow path 130 occurs in a radial direction extending from the axis of movement of the sealing element 124.

Of course, other structures of non-return valve can be implemented as the ambient valve. For example, a hinge-type valve or butterfly-type valve may also be applicable to the present disclosure.

It will be appreciated that, as the configuration (i.e., bypass or non-return configuration) of the ambient valve 120 is controlled by the position of the lockout lever 114 (which itself is controlled by the user’s inhalation), the ambient valve 120 may automatically switch from the bypass configuration to the non-return configuration when a user deeply inhales through the regulator 100.

In use, a user may don their breathing apparatus 10, including a regulator 100 according to the present disclosure. The regulator 100 may have the lockout lever 114 (pre)set in the lockout configuration and thus the ambient valve 120 (pre)set in the bypass configuration. During this time, the user case breathe the ambient air through the ambient valve 120 of the regulator 100, without wasting any pressurised gas stored in their cylinder 16. In this state, any delay experienced by the user before they respond to an incident has no impact on their supply of breathing gas stored in their cylinder 16.

However, as soon as the user begins to exert themselves and their cardiovascular demand increases (i.e., because they have begun to respond to an incident), their breathing volume and force will also increase. This change to more forceful breathing will automatically trigger the lockout lever 114 to move from the lockout configuration to the bypass configuration. Accordingly, the ambient valve 120 will automatically move from the bypass configuration to the non-return configuration. As a result, all further breaths taken by the user will be supplied from their cylinder via the demand valve 110, rather than from the ambient air via the ambient valve 120. Therefore, only at the moment when the user begins to respond to an incident does the ambient valve 120 switch from allowing ambient air to be inhaled to only permitting safe breathing gas from the cylinder 16 to be inhaled – thus minimising any wastage of breathing gas and maximising the amount of time available for the user to respond to the incident. In some examples, the user may also be able to move the ambient valve 120 to the non-return configuration by pressing on the outer surface of the sealing element 124 to force it inwards and overcome the retaining force of the lockout lever 114.

The biasing of the lockout lever 114 and/or the ambient valve 120 may be set such as to require a particular pressure gradient threshold between the internal chamber 103 and the ambient environment to be met before the ambient valve 120 will automatically switch from the bypass configuration to the non-return configuration. In some embodiments, the threshold may be met where the pressure in the internal chamber 103 is at least 0.5 kPa less than the ambient pressure. In some embodiments, the threshold may be met where the pressure in the internal chamber 103 is at least 0.65 kPa less than the ambient pressure.

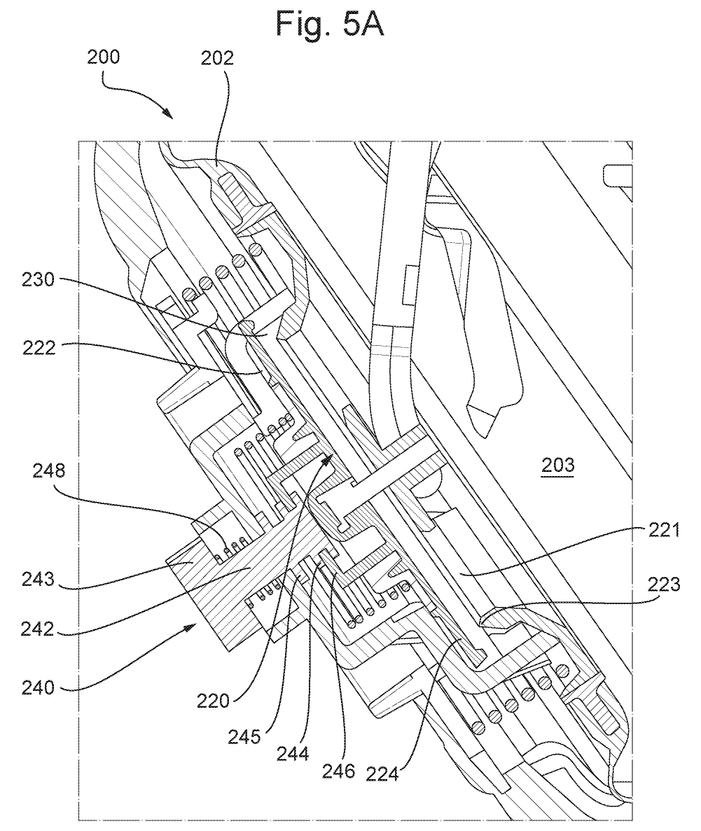

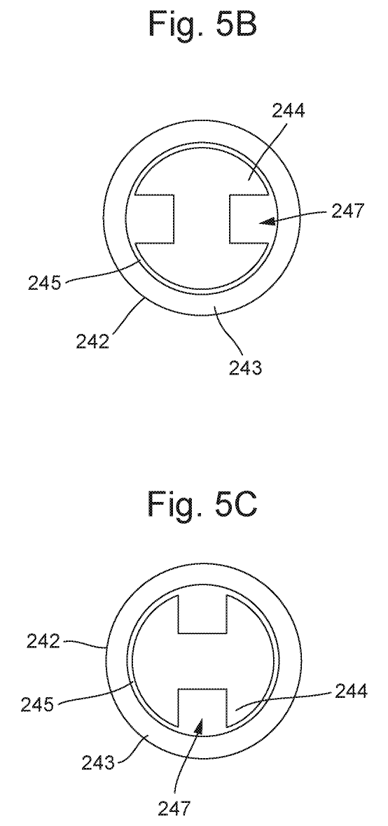

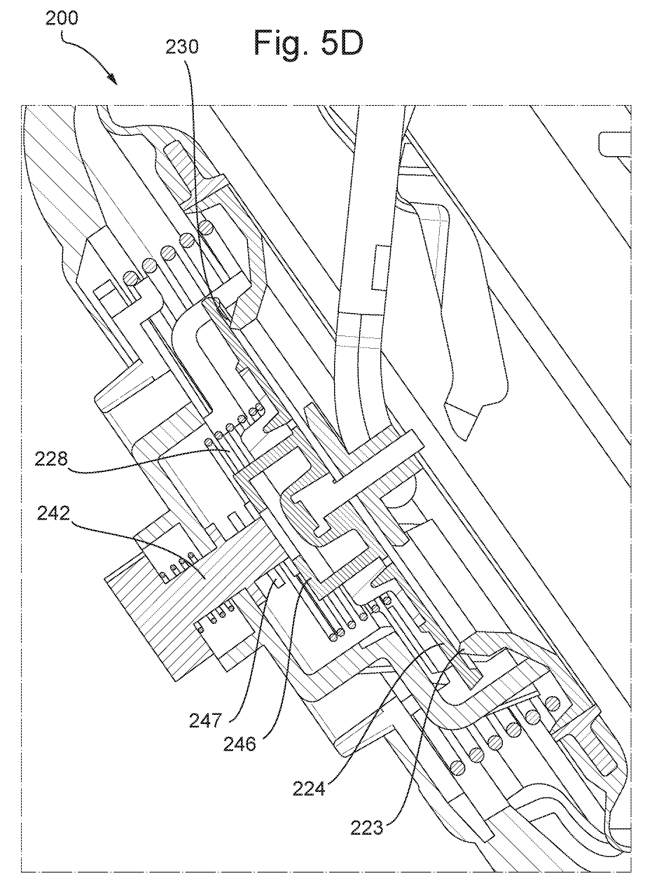

FIG. 5A depicts a further example embodiment of the present disclosure. Specifically, FIG. 5A depicts a portion of a cross-sectional view of a lung demand regulator according to a further example embodiment of the present disclosure. In this example embodiment, rather than operating automatically, the lockout mechanism is operated manually by a user.

In this example embodiment, the lockout mechanism is formed by a manual setting mechanism 240. The manual setting mechanism 240 comprises a rotatable setting element 242. FIG. 5A depicts the lockout mechanism in its lockout configuration in which the ambient valve 220 is held in the bypass configuration. The setting element 242 is biased by a biasing element 248. In this case, the biasing element 248 is a helical spring. The biasing element 248 engages an underside of a dial portion 243 of the setting element 242 and urges the setting element 242 in an outwards direction relative to the diaphragm 202. A stopper 245 holds the setting element 242 captive. The dial portion 243 extends from the regulator 200 such that a user is able to grasp and rotate the setting element 242.

The setting element 242 further comprises keying features 244 which, in the bypass configuration of the ambient valve 220, engages a flange 246 of the sealing element 224. As a result, the biasing element 248 also urges the sealing element 224 to separate from the sealing seat 223, opening the flow path 230 therebetween. In this configuration, the user is permitted to breathe through the ambient valve 220, inhaling from and exhaling into the ambient environment. As with the previous example embodiment, because the user can breathe through the ambient valve 220, no significant pressure gradient is built up in the internal chamber 203, so the lever 212 does not actuate the demand valve (not shown). In other words, in the bypass configuration, ambient air can freely pass through the ambient valve 220 between the first side 221 and the second side 222. Therefore, in the bypass configuration, no pressurised beathing gas is wasted.

FIG. 5B shows an isolated axial view of the setting element 242 of FIG. 5A. As shown, the setting element 242 includes keying features 244 which extend from a centre of the setting element 242. Between the keying features 244 are notches 247. FIG. 5B shows the setting element 242 in a first rotational position corresponding to the bypass configuration of the ambient valve 220. FIG. 5C shows the setting element in a second rotational position corresponding to the non-return configuration of the ambient valve 220. In this case, the second rotational position is 90 degrees from the first rotational position.

To move the ambient valve 220 from the bypass configuration to the non-return configuration, the user can manually rotate the setting element 242 from the first position (FIG. 5B) into the second position (FIG. 5C).

FIG. 5D shows the setting element 242 rotated into the second position in context with the ambient valve 220. In this position, the notches 247 are aligned with the flange 246 such that the setting element 242 can disengage from the sealing element 224 and the sealing element 224 can move relative thereto. As a result, the biasing element 248 no longer urges the sealing element 224 apart from the sealing seat 223. Instead, the biasing element 228 of the ambient valve 220 pushes against the sealing element 224 to seal against the sealing seat 223, thereby closing the flow path 230.

As the notches 247 are aligned with the flange 246 in the second position of the setting element 242, the sealing element 224 is free to move relative to the sealing seat 223 as it normally does in the non-return configuration. In other words, the setting element 242 can be rotated to either engage or disengage the sealing element 224 to move the ambient valve 220 between either the bypass configuration or the non-return configuration.

In some embodiments, the setting element may be movable to a third position in which the keying surfaces engage the flange in a different position to hold the sealing element against the sealing seat to effectively prevent the flow path from opening at all.

In use, a user may don their breathing apparatus 10 (which includes the regulator 200) and rotate the dial portion 243 so that the setting element 242 is in the first position, corresponding to the lockout configuration. In the lockout configuration, the ambient valve 220 is in the bypass configuration so the user can freely breathe ambient air through the ambient valve 220, without depleting their supply of pressurised breathing gas stored in their cylinder 16. Then, once the user is ready to begin responding to an emergency in an IDLH environment, the user can grasp and rotate the dial portion 243 so that the setting element 242 is in the second position, corresponding to the unlocked configuration. Once in the unlocked configuration, the ambient valve is in the non-return configuration so, when inhaling, the user is supplied with safe breathable gas via their cylinder 16. During exhalation, the user’s breath exists the regulator 200 via the flow path 230, which opens momentarily.

Of course, some embodiments of the present disclosure may incorporate a combination of the features of the example embodiment shown in FIGS. 4A and 4B and the features of the example embodiment shown in FIGS. 5A-5D.

Importantly, in all embodiments of the present disclosure, whether the configuration of the ambient valve is switched automatically or manually, the ambient valve reduces wastage of compressed breathing gas. This is achieved by minimising the amount of time the user spends breathing the compressed breathing gas before they have begun responding to an incident in an IDLH environment. As a result, the user has more time to respond to the incident in the IDLH environment.

It will be appreciated by those skilled in the art that the invention has been described by way of example with reference to one or more exemplary embodiments. However, the invention is not limited to the disclosed examples and alternative examples are envisioned and could be constructed without departing from the scope of the invention as defined by the appended claims.

1. A lung demand regulator for a breathing apparatus, the lung demand regulator comprising:
an ambient valve having:
a bypass configuration in which the ambient valve is configured to permit a flow of gas between a first side of the ambient valve and a second side of the ambient valve;
a non-return configuration in which the ambient valve is configured to permit a flow of gas from the first side of the ambient valve to the second side of the ambient valve and to prevent a flow of gas from the second side of the ambient valve to the first side of the ambient valve; and
a lockout mechanism having a lockout configuration in which the ambient valve is held in the bypass configuration, and an unlocked configuration in which the ambient valve is biased into the non-return configuration.

2. The lung demand regulator of claim 1, wherein the ambient valve comprises a sealing seat and a sealing element moveable relative to the sealing seat.

3. The lung demand regulator of claim 2, wherein the sealing element is biased to seal against the sealing seat.

4. The lung demand regulator of claim 2, wherein, in the lockout configuration, the lockout mechanism maintains a separation between the sealing element and the sealing seat to provide a flow path therebetween.

5. The lung demand regulator of claim 4, wherein the sealing element comprises an engagement portion extending through the sealing seat, and wherein the lockout mechanism is arranged to push against the engagement portion to separate the sealing element from the sealing seat.

6. The lung demand regulator of claim 2, wherein, in the unlocked configuration, biasing of the sealing element causes the sealing element to seal against the sealing seat.

7. The lung demand regulator of claim 2, wherein the sealing element is configured to move outwardly from the sealing seat relative to the lung demand regulator when the ambient valve opens.

8. The lung demand regulator of claim 2, wherein the sealing seat is an annular sealing seat and the sealing element is configured to move axially relative to the annular sealing seat.

9. The lung demand regulator of claim 2, wherein a direction of gas flow between the sealing element and the sealing seat is substantially perpendicular to a direction of movement of the sealing element.

10. The lung demand regulator of claim 2, further comprising a diaphragm between an internal chamber and the ambient environment.

11. The lung demand regulator of claim 10, wherein the ambient valve provides a flow path through the diaphragm between the internal chamber and the ambient environment.

12. The lung demand regulator of claim 10, wherein the lockout mechanism comprises a lockout lever, the lockout lever being configured to:
in the lockout configuration, engage the diaphragm and resist movement of the diaphragm when a pressure gradient between the internal chamber and the ambient environment is below a threshold; and
in the unlocked configuration, disengage the diaphragm and permit movement of the diaphragm when the pressure gradient between the internal chamber and the ambient environment exceeds the threshold.

13. The lung demand regulator of claim 12, wherein when the pressure gradient between the internal chamber and the ambient environment exceeds the threshold the sealing element pushes against the lockout lever to move the lockout mechanism into the unlocked configuration and move the ambient valve into the non-return configuration.

14. The lung demand regulator of claim 12, wherein the threshold corresponds to a pressure gradient where a pressure in the internal chamber is at least 5 kPa less than a pressure in the ambient environment or at least 6.5 kPa less than a pressure in the ambient environment.

15. The lung demand regulator of claim 12, wherein at least a portion of the sealing element extends from the lung demand regulator to permit a user to rotate the sealing element.

16. The lung demand regulator of claim 2, wherein the ambient valve comprises a manual setting mechanism configured to maintain the ambient valve in either the bypass configuration or the non-return configuration, and wherein the setting mechanism comprises a rotatable setting element having at least one keying feature extending radially therefrom, the setting element being rotatable into:
a first position corresponding to the bypass configuration in which the at least one keying feature engages the sealing element to separate the sealing element from the sealing seat; and
a second position corresponding to the non-return configuration in which the at least one keying feature disengages from the sealing element to permit the sealing element to seal against the sealing seat.

17. The lung demand regulator of claim 1, wherein gas flow through the ambient valve is an unfiltered gas flow.

18. A breathing apparatus comprising a lung demand regulator, wherein the lung demand regulator comprises:
an ambient valve having:
a bypass configuration in which the ambient valve is configured to permit a flow of gas between a first side of the ambient valve and a second side of the ambient valve;
a non-return configuration in which the ambient valve is configured to permit a flow of gas from the first side of the ambient valve to the second side of the ambient valve and to prevent a flow of gas from the second side of the ambient valve to the first side of the ambient valve; and
a lockout mechanism having a lockout configuration in which the ambient valve is held in the bypass configuration, and an unlocked configuration in which the ambient valve is biased into the non-return configuration.

19. The breathing apparatus of claim 18, wherein the ambient valve comprises a sealing seat and a sealing element moveable relative to the sealing seat.

20. The breathing apparatus of claim 19, wherein, in the lockout configuration, the lockout mechanism maintains a separation between the sealing element and the sealing seat to provide a flow path therebetween.
